(19) United States
(12) Patent Application Publication
(10) Pub. No.: US 2025/0381916 A1
(43) Pub. Date: Dec. 18, 2025

(54) TAILGATE SPOILER STORAGE SYSTEM

(71) Applicant: Toyota Motor Engineering & Manufacturing North America, Inc., Plano, TX (US)

(72) Inventors: Ryan C. Harris, Saline, MI (US); Scott Louis Frederick, Brighton, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/746,159

(22) Filed: Jun. 18, 2024

(51) Int. Cl. B60R 7/00; B62D 33/03

(52) U.S. Cl. CPC B60R 7/00; B62D 33/03

(57) ABSTRACT

The tailgate spoiler storage system described herein adds storage to a vehicle tailgate spoiler. The tailgate spoiler storage system includes 1) a tailgate pivotally connected to a cargo box of a vehicle and 2) a spoiler extending behind the tailgate. The spoiler includes 1) an upper member supported on a top surface of the tailgate, 2) a vertical member extending from the upper member along a rear surface of the tailgate, and 3) an angled bottom member extending between the vertical member and the upper member. The tailgate spoiler storage system also includes a pullout drawer disposed within, and laterally extendable from, the spoiler.

### TECHNICAL FIELD

The subject matter described herein relates, in general, to vehicle tailgates and, more particularly, to storage systems disposed within a vehicle tailgate.

### BACKGROUND

Some vehicles, which may be referred to as pickup trucks, include an open cargo space (i.e., a cargo box) behind a cab. Vertical side walls and a vertical front wall (i.e., adjacent to the pickup truck cab) rise from the cargo box surface. A tailgate, which pivotally opens and closes, forms a fourth wall of the cargo box. When an individual lowers the tailgate, they can load cargo into the cargo box. The tailgate is then raised to prevent the cargo from sliding out of the cargo box during transit. This cargo box provides ample space for cargo that may otherwise be impossible or difficult to transport in a non-truck-type vehicle.

### SUMMARY

In one embodiment, example systems and methods relate to a manner of improving storage in a vehicle, particularly a pickup truck with a cargo box. In one embodiment, a tailgate spoiler storage system with a pullout drawer is disclosed. The tailgate spoiler storage system includes 1) a tailgate pivotally connected to a cargo box of a vehicle and 2) a spoiler extending behind the tailgate. The spoiler includes 1) an upper member supported on a top surface of the tailgate, 2) a vertical member extending from the upper member along a rear surface of the tailgate, and 3) an angled bottom member extending between the vertical member and the upper member. The tailgate spoiler storage system further includes a pullout drawer disposed within, and laterally extendable from, the spoiler.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an isometric view of a vehicle with a tailgate spoiler storage system disposed therein.

FIG. 2 is a side view of the tailgate spoiler storage system attached to a vehicle.

FIG. 3 is an isometric view of an extended pullout drawer of a tailgate spoiler storage system with the tailgate in a lowered position.

FIG. 4 is a zoomed-in view of the measurement indicia on the pullout drawer of the tailgate spoiler storage system.

FIG. 5 is an isometric view of an extended tailgate spoiler storage system with two pullout drawers and the tailgate in a lowered position.

### DETAILED DESCRIPTION

The present tailgate spoiler storage system enhances the storage capacity of a vehicle, such as a pickup truck that includes a tailgate pivotally mounted to a cargo box. As previously described, pickup trucks include cargo boxes behind the cab. The cargo box generally includes a flat floor with lateral side walls extending vertically from the floor and a front wall extending vertically. A tailgate of the truck may be pivotally attached to the lateral side walls and transition between a closed position where the tailgate is vertical and an opened position where the tailgate is horizontal. The cargo box provides a large open area that can hold large objects or large quantities of objects.

While the cargo box of a pickup truck provides enhanced cargo carrying capacity, it may have a negative impact on the fuel economy and environmental impact of the pickup truck. In general, this is because the cargo box introduces aerodynamic inefficiencies. A vehicle with good aerodynamics promotes a particular airflow across the body, experiences less drag, and has better fuel economy than a vehicle with poor aerodynamics. Air flowing over a pickup truck cab gets caught in the open cargo box and swirls therein. These air swirls are characterized as turbulent flow and increase the drag on the pickup truck. As such, a pickup truck has greater drag and a reduced fuel economy.

To reduce the turbulent flow in the cargo box, reduce the pickup truck's drag, and increase the pickup truck's fuel economy, the tailgate of the cargo box may be fitted with a spoiler intended to increase the pickup truck's aerodynamics and reduce its drag. In general, the tailgate spoiler disrupts the airflow around the vehicle. This “spoiling” of this airflow increases the aerodynamic efficiency of the pickup truck, reduces the drag, and therefore increases the fuel economy of the pickup truck.

The tailgate spoiler also protects the surface of the tailgate. That is, the tailgate may be formed of a metallic material and susceptible to scratching. The tailgate spoiler may be formed of a plastic or resin material that protects the metallic tailgate from becoming scratched, for example, when objects are loaded into the cargo box.

In general, the tailgate spoiler has a triangular cross-sectional area, with a horizontal portion extending backward from the tailgate top surface (when in a raised position). An angled trailing edge extends between the distal point of the horizontal portion and the rear tailgate surface.

The storage system of the current specification utilizes the shape of the spoiler to house a pullout drawer. That is, the present tailgate spoiler storage system includes a pullout drawer housed within the body of the tailgate spoiler. The pullout drawer may match the shape of the triangular-shaped cross-sectional area and be slid into the tailgate spoiler. The pullout drawer provides a convenient place to store certain objects, such as long objects, which may be otherwise difficult to store in the pickup truck cab and/or cargo box.

Using a handle, a user may pull the drawer out to store various objects, including tools, keys, and construction equipment. Given its shape and size, the pullout drawer may be particularly suited to hold longitudinal objects such as fishing poles, golf clubs, or baseball bats or small construction equipment such as nails, screws, nuts, and bolts.

Thus, the tailgate spoiler storage system includes a compartment that can be accessed from the side of the tailgate when the tailgate is in a lowered position. When the drawer is closed and the tailgate is shut, a user can lock the tailgate, protecting stored items from theft when the user is not around. In one particular example, the surfaces of the pullout drawer may include measurement indicia, such that a user may measure the length of objects. For example, an electrician may be able to measure the length of electric cables when on a job site. In another example, a fisherman may measure the length of fishing line using the measurement indicia on the pullout drawer.

In an example, the pullout drawer may extend the entire length of the tailgate. In another example, the tailgate spoiler storage system may include two pullout drawers, one from either side of the tailgate. In this example, each pullout drawer may be approximately half the width of the tailgate or less.

In this way, the disclosed tailgate spoiler storage system provides an additional storage compartment in a vehicle, specifically a pickup truck that includes a tailgate spoiler. Moreover, the tailgate spoiler storage system further provides secure storage as the contents of the pullout drawer are secured from theft as the tailgate is lifted and the vehicle is locked.

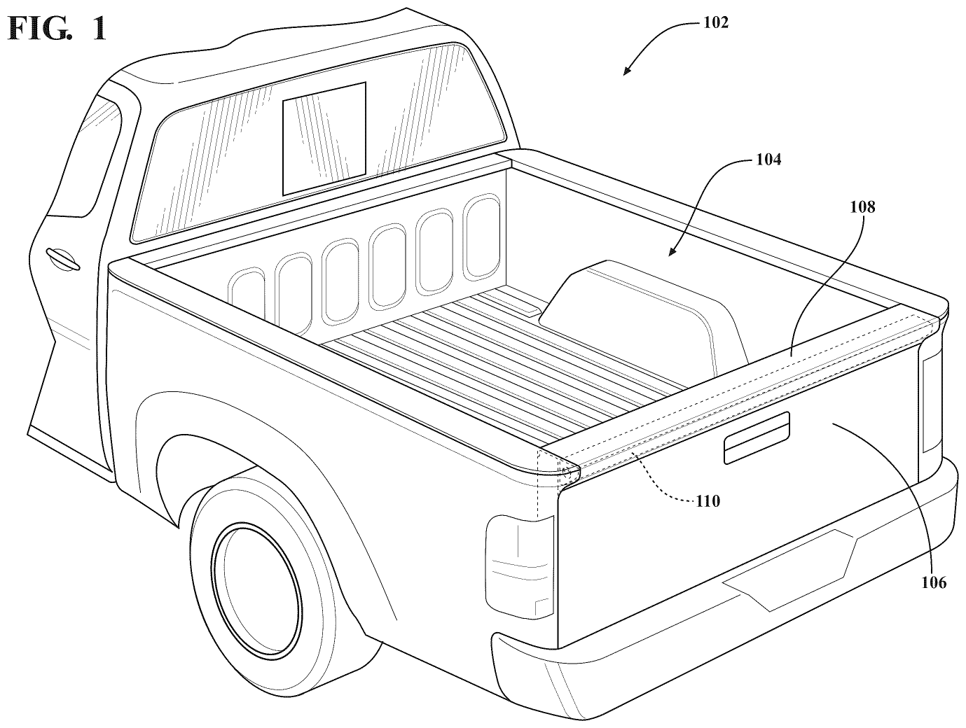

Turning now to the figures, FIG. 1 is an isometric view of a vehicle 102 with a tailgate spoiler storage system disposed therein. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, trucks are vehicles 102 with a cargo box 104 that can hold and haul large cargo and/or large quantities of cargo. The cargo box 104 generally includes a flat floor with lateral side walls extending vertically from the floor and a front wall extending vertically. A tailgate 106 of the truck may be pivotally connected to the cargo box 104 and specifically to the lateral side walls of the cargo box 104. The tailgate 106 transitions between a closed position where the tailgate 106 is vertical and an opened position where the tailgate 106 is horizontal. During hauling, the tailgate 106 is raised to form a fourth wall of the cargo box 104. With the tailgate 106 raised, the cargo, which may be secured with ropes, straps, tie-downs, or covers, may be easily transported. When lowered, the tailgate 106 is horizontal and aligns with the floor of the cargo box 104. As described above, the nature of the cargo box 104 with the open space creates aerodynamic inefficiencies that increase the drag and reduce the fuel economy of the truck through the generation of turbulent airflow across the vehicle 102.

Accordingly, the tailgate spoiler storage system includes a spoiler 108 extending behind the tailgate 106. In general, the spoiler 108 is intended to improve aerodynamics by reducing drag. Reduced drag and improved aerodynamics enhance vehicle 102 fuel economy.

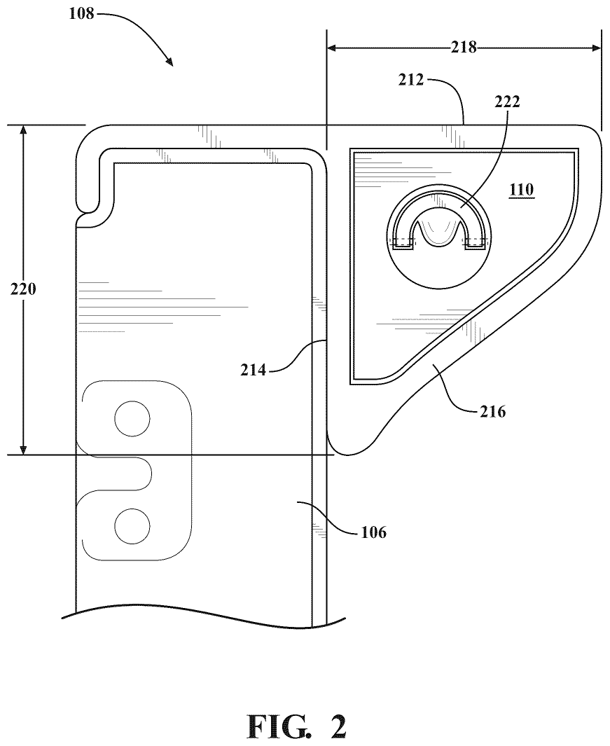

As depicted in FIG. 1, the spoiler 108 is mounted to the top surface of the tailgate 106 (where the top is defined as the most vertical surface of the tailgate 106 when raised). The spoiler 108 may have a triangular or wing-shaped cross-sectional area, as depicted in FIG. 2. The spoiler 108 may be made of a variety of materials, such as plastic or cured resin, and may be formed in various ways, including blow molding or injection molding. As a cover to the tailgate 106, the spoiler 108 may prevent damage to the main body of the tailgate 106, for example, when loading or unloading cargo from the vehicle 102.

In any example, the spoiler 108 may be a hollow component. That is, the cross-section of the spoiler 108 defines a volume therein. The tailgate spoiler storage system includes a pullout drawer 110 disposed within, and laterally extendable from, the spoiler 108 volume. In FIG. 1, the pullout drawer 110 is indicated in dashed lines to indicate its position within the volume of the spoiler 108. As with the spoiler 108, the pullout drawer may be formed of various materials, including plastic or resin, and may be formed through various manufacturing operations such as injection molding or blow molding. In another example, the spoiler 108 may be made of a metal material.

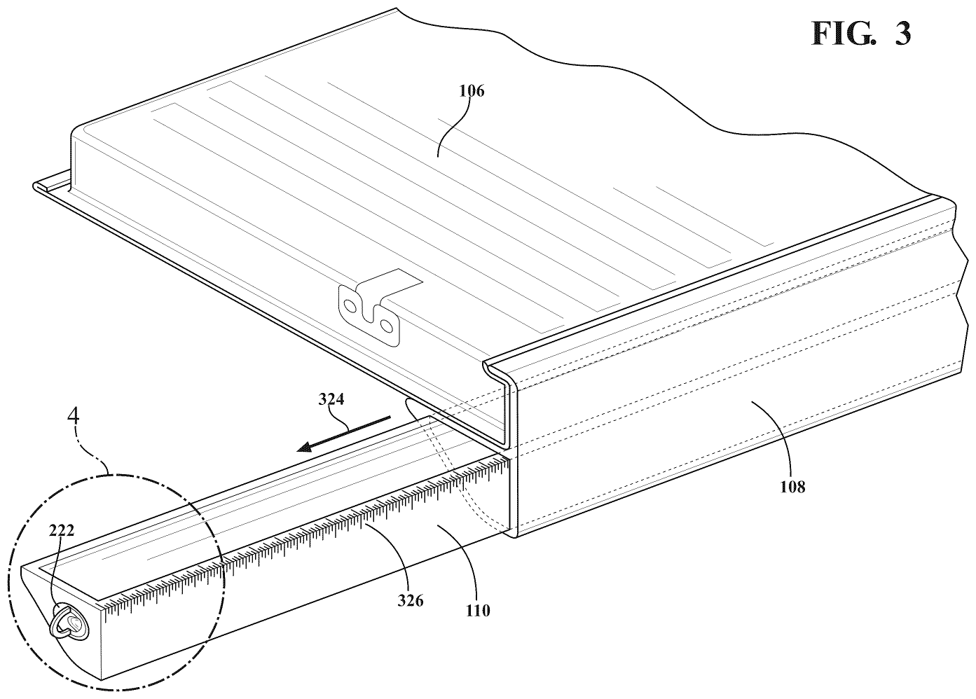

As described, and as depicted in FIG. 3, the pullout drawer 110 may extend laterally away from the tailgate 106. Specifically, the pullout drawer 110 may extend in a widthwise direction of the vehicle 102 perpendicular to the longitudinal axis of the vehicle 102.

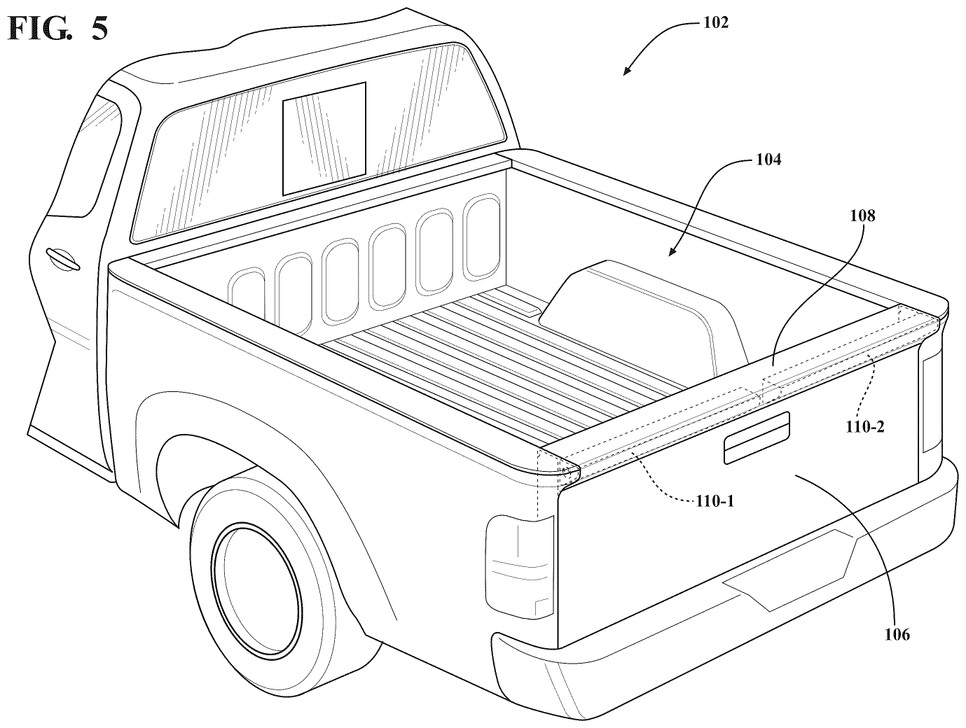

As depicted in FIG. 1, the pullout drawer 110 may occupy the entire width of the tailgate 106 and extend the full width of the tailgate 106. However, in other examples, such as that depicted in FIG. 5, the pullout drawer 110 may be shorter than the tailgate 106. For example, the pullout drawer 110 may be approximately half the length of the tailgate 106.

As depicted in FIG. 1, when the tailgate 106 is raised, the pullout drawer 110 is hidden within the body of the spoiler 108, thus hiding the contents from external observers. Moreover, the tailgate 106, individually or in combination with the doors of the vehicle 102, may be locked such that the contents of the pullout drawer 110 are securely stored.

FIG. 2 is a side view of the tailgate spoiler storage system attached to a vehicle 102. For simplicity, the lateral sidewalls of the cargo box 104 have been removed to illustrate certain components of the tailgate spoiler storage system.

As described above, the tailgate spoiler storage system includes a spoiler 108 on top of the tailgate 106. The spoiler 108 includes an upper member 212 that is supported on the top surface of the tailgate 106, with the top surface being defined as the most vertical surface of the tailgate 106 when the tailgate 106 is in a raised position. A portion of the upper member 212 rests on top of the top surface of the tailgate 106 and is mounted thereto, for example, via any number of devices such as screws, bolts, adhesives, interference snaps, or the like. A portion of the upper member 212 may extend beyond the tailgate 106. The amount that the upper member 212 extends beyond the tailgate 106 may vary based on a variety of characteristics such as aesthetics, dimensions of the vehicle 102 and tailgate 106, a target reduction in the drag of the vehicle 102, and a desired size for the pullout drawer 110 among others. In one particular example, the extended portion of the upper member 212 may have a length 218 of between 3-7 inches, for example, 5 inches. However, the extended portion of the upper member 212 may have any length 218.

The spoiler 108 includes a vertical member 214 extending from the upper member 212 along the rear surface of the tailgate 106. The vertical member 214 may provide structural support for the spoiler 108. In one example, vertical member 214 may provide additional fastening support for the spoiler 108 to the tailgate 106. For example, the vertical member 214 may include mating protrusions, snap-fit clasps, adhesive, or screw/bolt/rivet holes through which the spoiler 108 is affixed to the tailgate 106. As with the extended portion of the upper member 212, the length 220 of the vertical member 214 may vary based on several characteristics such as aesthetics, dimensions of the vehicle 102 and tailgate 106, a target reduction in the drag of the vehicle 102, and a desired size for the pullout drawer 110 among others. In one particular example, the vertical member 214 may have a length 220 of between 3-7 inches, for example, 5 inches. However, the vertical member 214 may have any length 220.

The spoiler 108 may also include an angled bottom member 216 extending between the vertical member 214 and the upper member 212. Specifically, the angled bottom member 216 extends from a distal, or trailing, end of the upper member 212 (i.e., the end of the upper member 212 farthest away from the tailgate 106) towards a distal end of the vertical member 214 (i.e., the lowest end of the vertical member 214).

The general shape of the spoiler 108 (i.e., triangular or wing-shaped), as depicted in FIG. 2, improves the airflow around the tailgate 106, which tailgate 106 is a contributing element towards the aerodynamic inefficiency of the vehicle 102. Moreover, as described above, the structural elements (i.e., the upper member 212, vertical member 214, and angled bottom member 216) define a volume where the pullout drawer 110 sits. As such, the pullout drawer 110 may have a height (in the direction of the vertical member 214) of between 3-7 inches and a depth (in the direction of the upper member 212) of between 3-7 inches. However, as with the dimensions of the upper member 212, vertical member 214, and angled bottom member 216, the dimensions of the pullout drawer 110 may vary based on several characteristics such as aesthetics, dimensions of the vehicle 102 and tailgate 106, a target reduction in the drag of the vehicle 102, and a desired size for the pullout drawer 110 among others. In one example, the dimensions of the pullout drawer 110 may also be defined, at least in part, by the thickness of the material that makes up the upper member 212, vertical member 214, and angled bottom member 216.

In an example, the pullout drawer 110 includes a handle 222 that is formed on, and flush with, an end surface of the pullout drawer 110. Accordingly, to extend the pullout drawer 110 as depicted in FIG. 3, a user may grasp the handle 222 and extend the pullout drawer 110 laterally. The handle 222 may take various forms. For example, the handle 222 may be molded into the pullout drawer 110. That is, in one example, the pullout drawer 110 is a molded component, and the mold may have a shape that defines a handle 222, such as a finger pull.

In another example, the handle 222 may be a hinged half-ring, as depicted in FIG. 3. In this example, the pullout drawer 110 may be molded with a recess. A pair of pins may support the half-ring handle 222 within the recess. Accordingly, a user may grasp the handle 222, rotate the half-ring, and pull laterally to extend the pullout drawer 110. While particular references are made to particular types of handles 222, the handle 222 may take various forms so long as it is flush with the tailgate 106. A flush handle 222, as described herein, allows a user to open the pullout drawer 110 without hindering the opening and closing of the tailgate 106.

FIG. 3 is an isometric view of an extended pullout drawer 110 from a tailgate spoiler storage system with the tailgate 106 in a lowered position. As described above, the pullout drawer 110 extends away from the tailgate 106 in a lateral direction 324. Specifically, when stowed, the pullout drawer 110 is entirely within the volume of the spoiler 108. A user may pull laterally on the handle 222, which extends the pullout drawer 110 in the lateral direction, where a lateral direction is defined as a direction perpendicular to the longitudinal axis of the vehicle 102.

In an example, the opening or top of the pullout drawer 110 faces the vertical member 214 of the spoiler 108. As such, the opening, when the tailgate 106 is in a lowered position, faces upward. Thus a user may readily access the contents of the pullout drawer 110 when the tailgate 106 is lowered. When closed, the content is prevented from spilling out because the vertical member 214 acts as a lid to the pullout drawer 110.

In an example, the pullout drawer 110 may be a single long compartment as depicted in FIG. 3. In this example, long objects such as fishing rods, golf clubs, baseball bats, rods of material such as rebar, pipes, and other long objects may be stored in the pullout drawer 110. The storage of these items or any other item stored in the pullout drawer 110 is secure because the pullout drawer 110 is hidden and inaccessible when the tailgate 106 is raised and locked.

In another example, the pullout drawer 110 may include dividers to form smaller compartments within the pullout drawer 110. In this example, smaller items, such as screws, nuts, bolts, fishing lures, or other small objects, may be stored in the pullout drawer 110 and maintained organized and separated.

In addition to being extendable from the tailgate spoiler 108, in an example, the pullout drawer is removable from the spoiler 108. For example, a user may continue to pull on the handle 222 in the lateral direction 324 and the pullout drawer 110 will slide out of the spoiler 108 volume entirely. This allows the pullout drawer 110 and the contents stored in the pullout drawer 110 to be transported away from the vehicle 102, for example, to a remote work site. As a particular example, a construction worker may store construction items such as nails, screws, bolts, nuts, etc. in the pullout drawer 114. Upon reaching the work site, the construction worker may remove the pullout drawer 110 and carry it to the site. Following use, the pullout drawer 110 may be re-inserted into the spoiler 108 for stowage and to secure the contents.

In an example, the tailgate spoiler storage system may include a structure to prevent the inadvertent removal of the pullout drawer 110. For example, a user may pull the handle 222 in the lateral direction 324 without knowing or paying attention to how much pullout drawer 110 remains in the spoiler 108. If pulled out too much without proper support by the user, the pullout drawer 110 may fall to the ground, and the contents may be spilled out and/or damaged.

Accordingly, the tailgate spoiler storage system may include a structure to prevent this inadvertent removal of the pullout drawer 110 from the spoiler 108. In an example, the structure may include a protrusion extending from the vertical member 214 into the opening of the pullout drawer 110. Upon extension, this protrusion or lip interfaces with the interior surface of the rear wall of the pullout drawer 110 to prevent translational removal of the pullout drawer 110. To remove the pullout drawer 110, a user may rotate the pullout drawer 110 until the lip no longer interfaces with the interior surface of the rear wall and remove the pullout drawer 110. To re-insert the pullout drawer 110, a user would first angle the end of the pullout drawer 110, i.e., the end of the pullout drawer 110 that does not include the handle 222 relative to the spoiler 108 volume, and then rotate the pullout drawer 110 such that the interior surface of the rear wall of the pullout drawer 110 is inside the volume and past the protrusion or lip. This arrangement prevents the inadvertent removal of the pullout drawer 110, which may result in the contents of the pullout drawer 110 falling out of the pullout drawer 110 and damage to the pullout drawer 110.

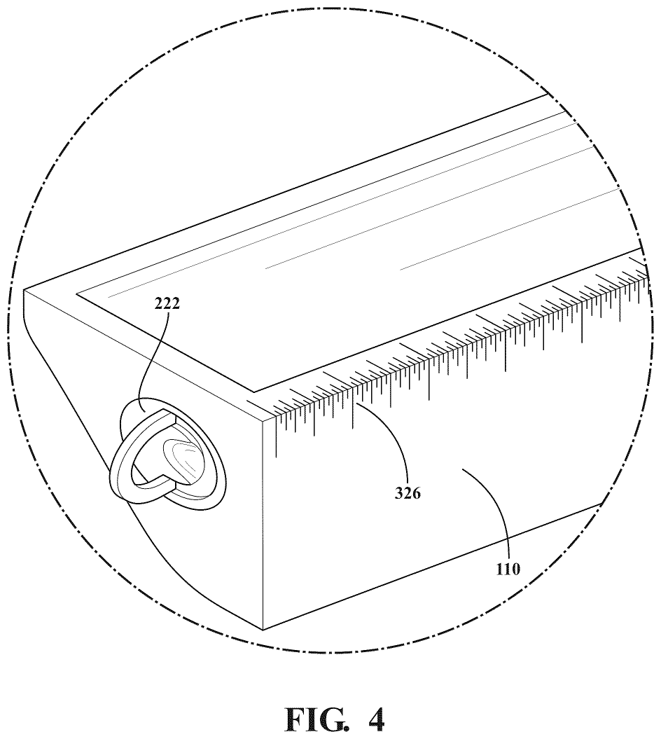

FIG. 4 is a zoomed-in view of the measurement indicia 326 on the pullout drawer 110 of the tailgate spoiler storage system. As described above, the tailgate spoiler storage system includes measurement indicia 326 on at least one surface of the pullout drawer 110. The measurement indicia 326 may extend along the pullout drawer 110 length. That is, as depicted in FIG. 4, the measurement indicia 326 may start (e.g., at 0 inches or at 0 mm) at the first portion of the pullout drawer 110 that extends from the spoiler 108 and may extend along a longitudinal direction of the pullout drawer 110. The measurement indicia 326 may extend any amount down the length of the pullout drawer 110. In one particular example, the measurement indicia 326 may extend the whole length of the pullout drawer 110.

The measurement indicia 326 may be according to any measurement standard. For example, the measurement indicia 326 may include imperial (e.g., inches and feet) indicia, metric indicia, or both imperial and metric indicia, with indicia values increasing along the length of the pullout drawer 110.

In an example, the surface on which the measurement indicia 326 is formed is the surface of the pullout drawer 110 that defines the opening of the pullout drawer 110. Put another way, the measurement indicia 326 may be formed on the top surface of the pullout drawer 110 when the the tailgate 106 is lowered. In this example, a user may rest an object on the top surface to obtain a measurement of the object.

The measurement indicia 326 may be formed in the pullout drawer 110 in various fashions. For example, the measurement indicia 326 may be printed on, molded into, or etched into a plastic/resin pullout drawer 110. In another example, the measurement indicia 326 are etched into a metal pullout drawer 110. In another example, the measurement indicia 326 may be printed on adhesive paper affixed to the pullout drawer 110. While particular references are made to particular types of measurement indicia 326, the measurement indicia 326 may be formed on the pullout drawer 110 in many ways.

In an example, the measurement indicia 326 may extend onto at least one additional surface of the pullout drawer 110. For example, as depicted in FIG. 4, the measurement indicia 326 may extend onto the surface of the pullout drawer 110 adjacent to upper member 212 of the spoiler 108. Providing measurement indicia 326 on two perpendicular surfaces of the pullout drawer 110 allows a user to measure an object from different orientations. For example, it may be that the object, when on the top surface of the pullout drawer 110, obscures the measurement indicia 326. Accordingly, in this example, the user may measure the object based on the portion of the measurement indicia that is on the second surface.

FIG. 5 is an isometric view of a tailgate spoiler storage system with two pullout drawers 110-1 and 110-2, with the tailgate 106 lowered. In FIG. 5, the indicators -* indicate specific instances of an element, while the lack of such an indicator references a general instance of the element. In this example, rather than a pullout drawer 110 extending a total length of the tailgate 106, each pullout drawer 110-1 and 110-2 extends a partial length of the tailgate 106. For example, a first pullout drawer 110-1 is laterally extendable from the spoiler 108 in a first lateral direction and a second pullout drawer 110-2 is disposed within the spoiler 108 and is laterally extendable from the spoiler 108 in a second lateral direction that is opposite the first lateral direction. The partial length pullout drawers 110 may be various lengths. For example, the combined length of the first pullout drawer 110-1 and the second pullout drawer 110-2 may match or approximate the length of the tailgate 106. In other examples, the combined length of the partial-length pullout drawers 110-1 and 110-2 is less than the entire width of the tailgate 106. In either case, two pullout drawers 110-1 and 110-2 increase the storage system's customization for various uses.

As such, the present tailgate spoiler storage system utilizes previously wasted space in a tailgate spoiler 108 to house a pullout drawer 110 where objects can be stored. The storage space is secured as the pullout drawer 110 is inaccessible while the tailgate 106 is raised and the vehicle 102 is locked.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A tailgate spoiler storage system, comprising:
a tailgate pivotally connected to a cargo box of a vehicle;
a spoiler extending behind the tailgate, the spoiler comprising:
an upper member supported on a top surface of the tailgate;
a vertical member extending from the upper member along a rear surface of the tailgate; and
an angled bottom member extending between the vertical member and the upper member; and
a pullout drawer disposed within, and laterally extendable from, the spoiler.

2. The tailgate spoiler storage system of claim 1, wherein an opening in the pullout drawer faces the vertical member of the spoiler so the opening faces upward when the tailgate is in a lowered position.

3. The tailgate spoiler storage system of claim 1, further comprising a handle formed on and flush with an end surface of the pullout drawer.

4. The tailgate spoiler storage system of claim 1, further comprising measurement indicia formed on at least one surface of the pullout drawer.

5. The tailgate spoiler storage system of claim 4, wherein the measurement indicia extend onto at least an additional surface of the pullout drawer.

6. The tailgate spoiler storage system of claim 4, wherein the at least one surface of the pullout drawer is a surface that defines an opening of the pullout drawer.

7. The tailgate spoiler storage system of claim 1, wherein the pullout drawer extends a whole length of the tailgate.

8. The tailgate spoiler storage system of claim 1, wherein the pullout drawer extends a partial length of the tailgate.

9. The tailgate spoiler storage system of claim 8:
wherein the pullout drawer is laterally extendable from the spoiler in a first lateral direction; and
the tailgate spoiler storage system further comprises a second pullout drawer disposed within, and laterally extendable from, the spoiler in a second lateral direction that is opposite the first lateral direction.

10. The tailgate spoiler storage system of claim 1, wherein the pullout drawer is removable from the spoiler.
